(19) United States
(12) Patent Application Publication
(10) Pub. No.: US 2026/0203042 A1
(43) Pub. Date: Jul. 16, 2026

(54) SOFTWARE UPDATE SYSTEM, SOFTWARE UPDATE DEVICE, SOFTWARE UPDATE METHOD, AND STORAGE MEDIUM

(71) Applicant: HONDA MOTOR CO., LTD., TOKYO (JP)

(72) Inventors: Yujiro KOMIYAMA, TOKYO (JP); Yutaro YASUDA, TOKYO (JP); Yasumasa KAITANI, TOKYO (JP)

(21) Appl. No.: 19/446,380

(22) Filed: Jan. 12, 2026

(30) Foreign Application Priority Data
Jan. 14, 2025 (JP) 2025-004831

(51) Int. Cl. G06F 8/65; B60R 16/023

(52) U.S. Cl. CPC G06F 8/65; B60R 16/0231

(57) ABSTRACT

A software update system includes a start-stop switch capable of switching the power mode of a vehicle, and an update processing unit configured to execute a software update process when the power mode is IG-OFF, wherein a transmission processing unit stops a transmission process and the update processing unit executes the software update process if the transmission process has not succeeded at the time when the power mode is switched from IG-ON to IG-OFF.

### CROSS-REFERENCE TO RELATED APPLICATIONS

This application is based upon and claims the benefit of priority from Japanese Patent Application No. 2025-004831 filed on Jan. 14, 2025, the contents of which are incorporated herein by reference.

### BACKGROUND OF THE INVENTION

### Field of the Invention

The present disclosure relates to a software update system, a software update device, a software update method, and a storage medium.

### Description of the Related Art

JP 2024-067404 A discloses a software management system (software update system). In the software management system, a process related to software update using OTA (Over The Air) is performed.

### SUMMARY OF THE INVENTION

Better software update systems and the like are awaited.

The present disclosure aims to solve the aforementioned problems.

A first aspect of the present disclosure is a software update system including a vehicle, a server device configured to communicate with the vehicle via a network, a power mode switch configured to switch, based on an operation by a user, the power mode of the vehicle to at least one of a first mode in which a first number of electrical components among a plurality of electrical components mounted on the vehicle are operable and a second mode in which a second number of the electrical components smaller than the first number are operable, a transmission processing unit configured to execute a transmission process for transmitting data to the server device, and an update processing unit configured to execute a software update process for an electronic control unit provided in the vehicle in a case where the power mode is the second mode, wherein the transmission processing unit stops the transmission process and the update processing unit executes the software update process in a case where the transmission process has not succeeded at the time when the power mode is switched from the first mode to the second mode.

A second aspect of the present disclosure is a software update device in the software update system according to the first aspect, the software update device including the transmission processing unit and the update processing unit.

A third aspect of the present disclosure is a software update method for performing a software update process for an electronic control unit in a vehicle. The vehicle includes a power mode switch configured to switch, based on an operation by a user, the power mode of the vehicle to at least one of a first mode in which a first number of electric components among a plurality of electric components mounted on the vehicle are operable and a second mode in which a second number of electric components smaller than the first number are operable. The software update method include a transmission processing step in which a transmission processing unit executes a transmission process for transmitting data to a server device configured to communicate with the vehicle via a network, and an update processing step in which the software update process is executed by the update processing unit in a case where the power mode is the second mode, wherein in a case where the transmission process has not succeeded at the time when the power mode is switched from the first mode to the second mode, the transmission processing unit stops the transmission process in the transmission processing step, and the update processing unit executes the software update process in the update processing step.

A fourth aspect of the present disclosure is a program for causing a computer to execute the software update method according to the third aspect.

A fifth aspect of the present disclosure is a computer-readable, non-transitory storage medium containing a program according to the fourth aspect.

According to the present disclosure, a better software update system and the like can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram illustrating a software update system according to an embodiment;

FIG. 2 is a flow diagram of a software update process according to one embodiment;

FIG. 3 is a flow chart showing software update control performed by a software update device according to one embodiment;

FIG. 4 is a flow chart showing software update control performed by the software update device according to one embodiment;

FIG. 5 is a diagram for explaining the operation of the software update device;

FIG. 6 is a diagram for explaining the operation of the software update device; and

FIG. 7 is a diagram for explaining the operation of the software update device.

### DETAILED DESCRIPTION OF THE INVENTION

Conventionally, software update for a vehicle-mounted electronic control unit (ECU) was performed at a dealer or the like. Recently, vehicles capable of updating ECU software via OTA (over the air) using wireless communication have been commercially available, and such vehicles can update ECU software without being brought to a dealer or the like.

In the software update process via OTA, the ECU may need to be restarted during the process of software activation. Therefore, software activation is performed during parking that is when a driving source such as a vehicle engine, a driving motor, or the like is stopped. While the software activation is taking place, the driving source cannot be activated, leaving the vehicle unable to travel. The period during which the drive source cannot be started due to the activation of the software is referred to as downtime.

After the driving source of the vehicle stops and it is determined that the vehicle has been parked, and before the software activation starts, a confirmation process is performed to confirm with a user whether or not to grant downtime. In the confirmation process, downtime permission information is displayed on a display unit of an in-vehicle infotainment (IVI) system or the like. The downtime permission information includes information on the name and version of the software to be activated, information for requesting the user's permission for downtime, and the like. In the case that the approval of the user with respect to the downtime is obtained, the activation of the software is started.

It is possible that the user will exit the vehicle after the parking of the vehicle is completed. If the user exits the vehicle before the user's decision on downtime is indicated, the software activation cannot begin. Therefore, the confirmation process needs to be performed quickly after the parking is completed.

In the software update process, a transmission process is performed in which data is transmitted from the vehicle to the server device. If the transmission process fails, a transmission retry is performed that performs the transmission process again. The transmission retry is repeated until the transmission process succeeds or a predetermined time elapses since the start of the transmission process.

Because the confirmation process for confirming with the user whether to permit the downtime and the transmission process cannot be performed simultaneously, a request for stopping the transmission process is output when the parking of the vehicle is completed. After the transmission process is stopped based on the request for stopping the transmission process, the confirmation process is performed. However, in the conventional art, when the transmission retry is being performed at the time point when the parking of the vehicle is completed, the transmission retry does not immediately stop even if the request for stopping transmission process is output and the transmission retry continues until the transmission process succeeds or until a predetermined time elapses from the start of the transmission process.

If the communication environment at the place where the vehicle is parked is not favorable and the transmission process is not successful, there is a possibility that the transmission retry will not stop until a predetermined time elapses from the start of the transmission process. Therefore, it sometimes takes a relatively long time from when parking is completed to when the confirmation process is performed.

According to the present disclosure, even when the communication environment is not favorable, the confirmation process for confirming with the user whether or not to permit the downtime can be performed favorably.

### Embodiment

A software update system, a software update device, a software update method, a program, and a computer-readable non-transitory storage medium according to an embodiment will be described below with reference to the drawings. A program (computer program, computer software) according to the present embodiment may also be referred to as a computer program product. The computer program product is not limited to being a computer program that is recorded on a recording medium, but may also include a computer program that is transmitted, distributed, or downloaded via the Internet or the like.

### Configuration of Software Update System

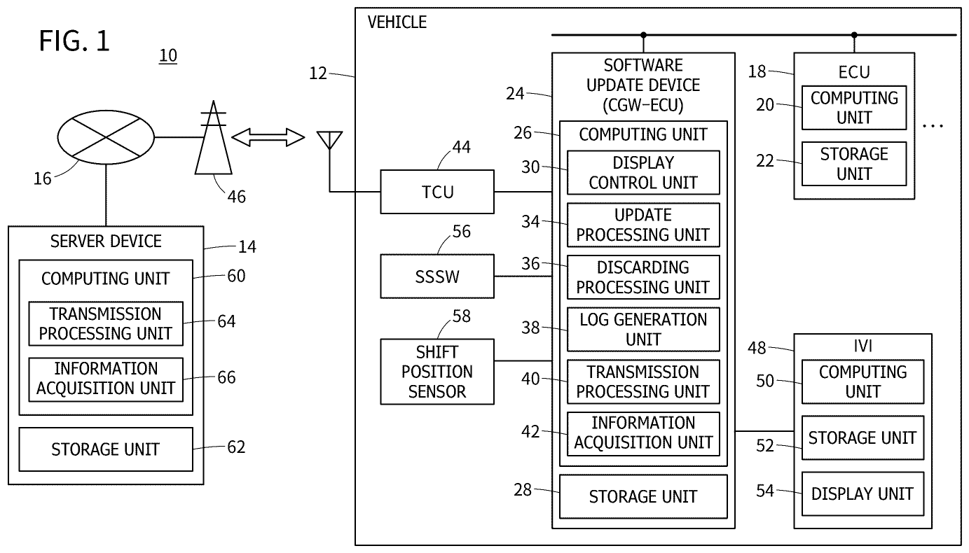

FIG. 1 is a schematic diagram illustrating a software update system 10 according to an embodiment. The software update system 10 includes a vehicle 12 and a server device 14. The server device 14 is capable of communicating with the vehicle 12 via a network 16.

The vehicle 12 is equipped with a plurality of ECUs 18. Each ECU 18 performs control to implement a traveling function and other functions of the vehicle 12. Each ECU 18 has a computing unit 20 and a storage unit 22. The computing unit 20 is a processor such as a CPU (Central Processing Unit), a GPU (Graphics Processing Unit), or the like. At least part of the computing unit 20 may be realized by an integrated circuit such as an ASIC (Application Specific Integrated Circuit), an FPGA (Field-Programmable Gate Array), or the like. At least part of the computing unit 20 may be realized by an electronic circuit including discrete devices.

The storage unit 22 is a computer-readable, non-transitory tangible storage medium. The storage unit 22 is composed of a volatile memory (not shown) and a nonvolatile memory (not shown). The volatile memory is, for example, RAM (Random Access Memory) or the like. The nonvolatile memory is, for example, ROM (Read Only Memory), flash memory, or the like. Data or the like are stored, for example, in the volatile memory. Programs, tables, maps, or the like are stored, for example, in the non-volatile memory. At least part of the storage unit 22 may be provided in the above-mentioned processor, integrated circuit, or the like. At least part of the storage unit 22 may be mounted in a device connected to the vehicle 12 via the network 16.

The vehicle 12 is equipped with a software update device 24. The software update device 24 may be constituted by, for example, a CGW-ECU (Central GateWay-Electronic Control Unit). The software update device 24 has a computing unit 26 and a storage unit 28. The computing unit 26 is, for example, a processor such as a CPU or a GPU. The computing unit 26 includes a display control unit 30, an update processing unit 34, a discarding processing unit 36, a log generation unit 38, a transmission processing unit 40, and an information acquisition unit 42. The display control unit 30, the update processing unit 34, the discarding processing unit 36, the log generation unit 38, the transmission processing unit 40, and the information acquisition unit 42 are realized by the computing unit 26 executing programs stored in the storage unit 28. At least part of the display control unit 30, the update processing unit 34, the discarding processing unit 36, the log generation unit 38, the transmission processing unit 40, and the information acquisition unit 42 may be realized by an integrated circuit such as an ASIC or an FPGA. At least part of the display control unit 30, the update processing unit 34, the discarding processing unit 36, the log generation unit 38, the transmission processing unit 40, and the information acquisition unit 42 may be realized by an electronic circuit including discrete devices.

The storage unit 28 is a computer-readable, non-transitory tangible storage medium. The storage unit 28 is composed of a volatile memory (not shown) and a nonvolatile memory (not shown). The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 28 may be provided in the above-mentioned processor, integrated circuit, or the like. At least part of the storage unit 28 may be mounted in a device connected to the vehicle 12 via the network 16.

The software update device 24 performs the software update process for the ECU 18. The software update process includes software download, software installation, and software activation.

Software download means acquiring update data transmitted from the server device 14 via the network 16 and storing the data in the storage unit 28 of the software update device 24. The update data is data including a program or the like of the updated software. The update data may include an installer or the like.

The installation of the software indicates loading the updating data from the storage unit 28 into ROMs of the ECUs 18. The software installation may be performed by an installer. Software installation may be performed by copying update data to the ROM.

Software activation means the process of authenticating the license of installed software. Executable files, etc. used by the prior-to-updating software may be rewritten during the activation of software. Upon completion of the software activation, the execution of the software is allowed in the ECU 18. Activation may be performed by the software update device 24 or each ECU 18.

The display control unit 30 controls the IVI 48, which will be described later, to display campaign information, downtime permission information, and so on, which will be described later, on a display unit 54 of the IVI 48. The update processing unit 34 performs a confirmation process to confirm with the user whether to execute software download, software activation, and the like. These confirmation processes may be included in the software update process. The update processing unit 34 also performs software downloading, software installation, and software activation. The discarding processing unit 36 performs a discarding process for discarding the acquired campaign information stored in the storage unit 28.

The log generation unit 38 generates a result log. The log generation unit 38 generates a result log when the software update is completed, when the software update process is aborted without completing the software update, or when the software update fails. The log generation unit 38 may generate an event log. The event log is generated when a predetermined process of the software update process starts or when the predetermined process ends.

The transmission processing unit 40 transmits various kinds of information to the server device 14. The transmission processing unit 40 transmits the result log and the event log to the server device 14. The transmission processing unit 40 transmits configuration synchronization information, an update data request, and the like, which will be described later, to the server device 14.

The information acquisition unit 42 acquires various kinds of information transmitted from the server device 14. The information acquisition unit 42 acquires a configuration synchronization request, campaign information, update data, and the like, which will be described later.

The software update device 24 and the ECU 18 are connected by a CAN (Controller Area Network) (registered trademark in Japan) and can communicate with each other. A communication line connecting the software update device 24 and the ECU 18 is not limited to the CAN and may be an Ethernet (registered trademark in Japan), or both the CAN and the Ethernet may be used. Furthermore, as the communication line, a communication line according to other standards than CAN and Ethernet may be used.

The software update device 24 is capable of communicating, via a Telematics Control Unit (TCU) 44, with a base station 46 connected to the network 16 through cellular communication. The network 16 is, for example, the Internet.

The IVI 48 is connected to the software update device 24. The IVI 48 has a computing unit 50 and a storage unit 52. The computing unit 50 is, for example, a processor such as a CPU or a GPU.

The storage unit 52 is a computer-readable, non-transitory tangible storage medium. The storage unit 52 is composed of a volatile memory (not shown) and a nonvolatile memory (not shown). The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 52 may be provided in the above-mentioned processor, integrated circuit, or the like. At least part of the storage unit 52 may be mounted in a device connected to the vehicle 12 via the network 16.

The IVI 48 provides information such as display of road traffic information and route guidance and also provides entertainment through audio, DVD, TV tuner, and so on.

The IVI 48 has a display unit 54. The display unit 54 is installed on a dashboard or the like of the vehicle 12. The display unit 54 is a touch panel display. The display unit 54 provides the user with information in the form of images, characters, and so on and accepts operation input performed by the user. The screen of the display unit 54 is not particularly limited and may be a liquid crystal, organic electroluminescence (organic EL), or the like. The touch panel of the display unit 54 is not particularly limited and may be a resistive film type, a capacitance type, or the like. Instead of the display unit 54 that is a touch panel display, a combination of a display device such as a head-up display and a pointing device such as motion capture may be used.

The vehicle 12 is equipped with a start-stop switch (SSSW) 56. The power mode of the vehicle 12 is switched by the user operating the SSSW 56. The SSSW 56 corresponds to a power mode switch of the present invention. When the vehicle 12 is an engine vehicle, the power modes include IG-ON, IG-OFF, ACC-ON, ACC-OFF, and START. When the vehicle 12 is a hybrid vehicle or a motorized vehicle, there are IG-ON, IG-OFF, ACC-ON, ACC-OFF, and READY.

In the IG-ON mode, all electrical components of the vehicle 12 can be used. In the ACC-ON mode, some electrical components such as audio can be used. In the ACC-OFF mode, except some electrical components such as a keyless entry system, electrical components cannot be used. A state other than IG-ON is IG-OFF, and IG-OFF includes ACC-ON and ACC-OFF. The number of electrical components that are operational in the IG-OFF mode is less than the number of electrical components that are operational in the IG-ON mode. IG-ON corresponds to a first mode of the present invention, and IG-OFF corresponds to a second mode of the present invention.

In the START mode, a starter motor is actuated to start the engine. After the engine start-up is completed, the transition to IG-ON is made. In the READY mode, the drive motor is allowed to be actuated and the vehicle 12 can be driven by the drive motor. The power mode when the hybrid vehicle and the electric vehicle are drivable is IG-ON and READY.

The vehicle 12 is equipped with a shift position sensor 58. The shift position sensor 58 detects a selected shift position. The parking position (P position), neutral position (N position), drive position (D position), reverse position (R position), and so on can be selected as shift positions.

The server device 14 has a computing unit 60 and a storage unit 62. The computing unit 60 is, for example, a processor such as a CPU or a GPU. The computing unit 60 includes a transmission processing unit 64 and an information acquisition unit 66. The transmission processing unit 64 and the information acquisition unit 66 are realized by the computing unit 60 executing programs stored in the storage unit 62. At least part of the transmission processing unit 64 and the information acquisition unit 66 may be realized by an integrated circuit such as an ASIC or an FPGA. At least part of the transmission processing unit 64 and the information acquisition unit 66 may be realized by an electronic circuit including discrete devices.

The storage unit 62 is a computer-readable, non-transitory tangible storage medium. The storage unit 62 is composed of a volatile memory (not shown) and a nonvolatile memory (not shown). The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 62 may be provided in the above-mentioned processor, integrated circuit, or the like. At least part of the storage unit 62 may be mounted in a device connected to the server device 14 via the network 16.

A plurality of vehicles 12 are registered in the server device 14, and the update status of the software of the ECU 18 of each vehicle 12 is managed. The server device 14 provides each vehicle 12 with the update data for updating the software of the ECU 18 of each vehicle 12.

The transmission processing unit 64 transmits various kinds of information to the vehicle 12. The transmission processing unit 64 transmits a configuration synchronization request, campaign information, update data, and the like, which will be described later, to the vehicle 12. The information acquisition unit 66 acquires various kinds of information transmitted from the vehicle 12. The information acquisition unit 66 acquires result logs and event logs. The information acquisition unit 66 acquires configuration synchronization information, an update data request, and the like, which will be described later.

### Flow of Software Update Process

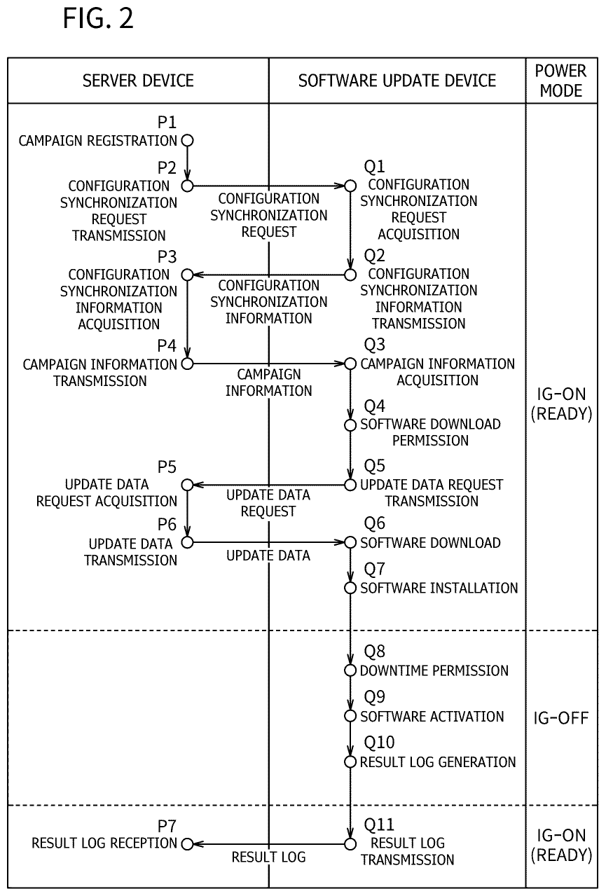

FIG. 2 is a flow diagram of a software update process according to one embodiment.

When the campaign is registered in the server device 14 (P1), the transmission processing unit 64 of the server device 14 transmits a configuration synchronization request to the software update device 24 of the vehicle 12 (P2) (in FIG. 2, the configuration synchronization request is made from the server device 14 but the configuration synchronization request may be made from the vehicle 12 side). The campaign, together with the update data for updating the software of the ECU 18, is registered in the server device 14 by a software developer of the ECU 18, a manufacturer of the vehicle 12, and so on.

When the information acquisition unit 42 of the software update device 24 acquires the configuration synchronization request (Q1), the transmission processing unit 40 transmits the configuration synchronization information to the server device 14 (Q2). The configuration synchronization information includes information on a unique identifier assigned to each ECU 18 of the vehicle 12, information on a version of the software of each ECU 18, and the like.

When the information acquisition unit 66 of the server device 14 acquires the configuration synchronization information (P3), the transmission processing unit 64 transmits to the software update device 24 the campaign information on the software update process for each ECU 18 (P4).

The information acquisition unit 42 of the software update device 24 acquires the campaign information (Q3) and stores the campaign information in the storage unit 28. The display control unit 30 causes the display unit 54 of the IVI 48 to display the campaign information. The confirmation process for confirming with the user whether to permit the software download is performed by the update processing unit 34. In this confirmation process, when the user permits the software download (Q4), the transmission processing unit 40 of the software update device 24 transmits an update data request to the server device 14 (Q5).

When the information acquisition unit 66 of the server device 14 acquires the update data request (P5), the transmission processing unit 64 transmits the update data to the software update device 24 (P6).

The information acquisition unit 42 of the software update device 24 acquires the update data, and the update processing unit 34 stores the update data in the storage unit 28, whereby the software is downloaded (Q6). Then, the update processing unit 34 loads the update data of the storage unit 28 into the ROM of the ECU 18, whereby the software is installed in the ECU 18 (Q7).

Before the software activation starts, the update processing unit 34 of the software update device 24 performs the confirmation process to confirm with the user whether to permit downtime. If the shift position detected by the shift position sensor 58 is “P” at the time when the power mode transitions from IG-ON (or READY) to IG-OFF, the confirmation process is executed. In this confirmation process, if the user permits downtime (Q8), the update processing unit 34 of the software update device 24 activates the software of the ECU 18 (Q9). The downtime indicates a time period during which the power mode of the vehicle 12 cannot be set to the START mode or the READY mode and the vehicle 12 cannot start traveling while the software activation is performed.

When the software activation of the ECU 18 is completed, the log generation unit 38 of the software update device 24 generates a result log (Q10). Once the result log is generated, the software update device 24 shuts down.

When the power mode transitions from IG-OFF to IG-ON (or READY), the software update device 24 is activated. After the software update device 24 is activated, the transmission processing unit 40 transmits the result log to the server device 14 (Q11).

When the information acquisition unit 66 of the server device 14 acquires the result log (P7), the series of software updates is completed.

### Software Update Control

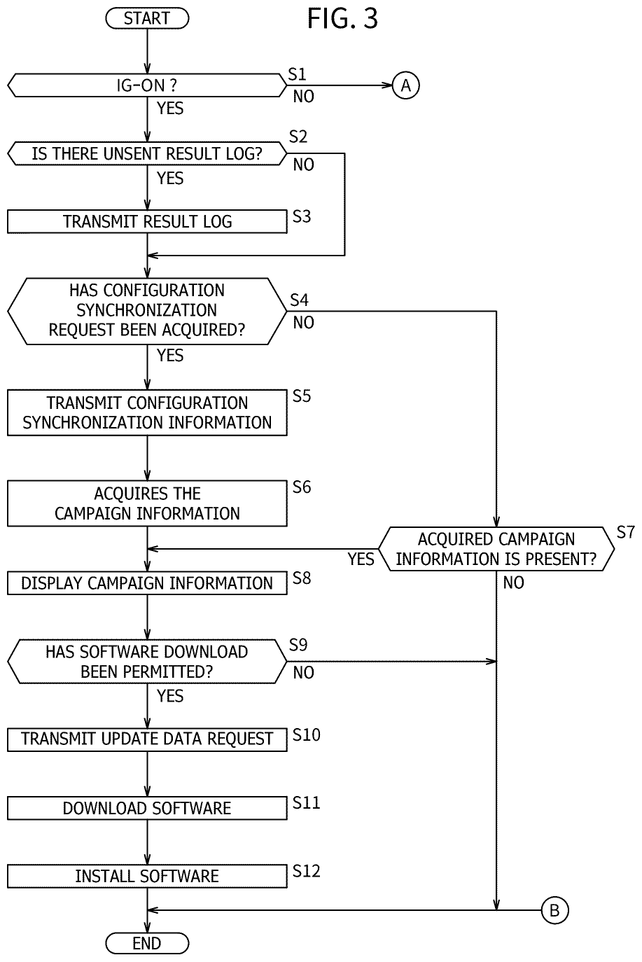

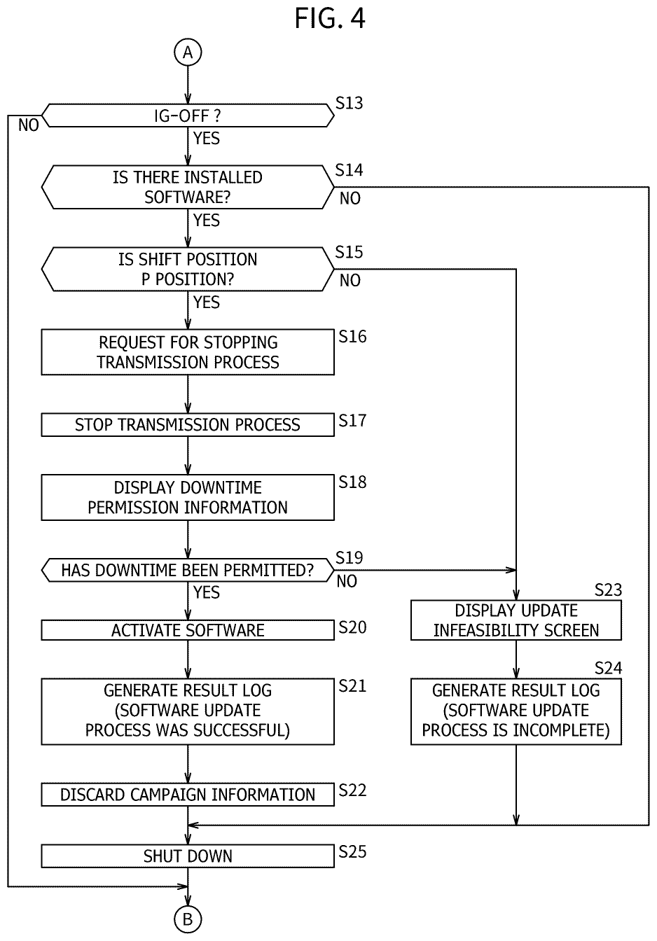

FIGS. 3 and 4 are a flow chart showing the software update control performed by the software update device 24 according to one embodiment. This software update control is executed at a predetermined cycle while the software update device 24 is in operation.

In step S1, the transmission processing unit 40 of the software update device 24 determines whether the power mode of the vehicle 12 is IG-ON. If it is determined that the power mode is IG-ON (step S1: YES), the process proceeds to step S2.

In step S2, the transmission processing unit 40 of the software update device 24 determines whether there is an unsent result log. If it is determined that there is an unsent result log, the process proceeds to step S3. If it is determined that there is no unsent result log, the process proceeds to step S4.

In step S3, the transmission processing unit 40 of the software update device 24 transmits the result log to the server device 14. Then, the process proceeds to step S4.

In step S4, the information acquisition unit 42 of the software update device 24 determines whether or not the configuration synchronization request has been acquired from the server device 14 (in the example of FIG. 3, the configuration synchronization request is made from the server device 14 but may be made from the vehicle 12). If it is determined that the configuration synchronization request has been acquired (step S4: YES), the process proceeds to step S5.

In step S5, the transmission processing unit 40 of the software update device 24 transmits the configuration synchronization information to the server device 14. Then, the process proceeds to step S6.

In step S6, the information acquisition unit 42 of the software update device 24 acquires the campaign information and stores the acquired campaign information in the storage unit 28.

If it is determined in step S4 that the configuration synchronization request has not yet been acquired (step S4: NO), the process proceeds to step S7. In step S7, the software update device 24 determines whether or not the acquired campaign information is present in the storage unit 28. If it is determined that the acquired campaign information is not in the storage unit 28 (step S7: NO), the software update control is terminated.

After the process of the step S6 is completed or when it is determined in the step S7 that the acquired campaign information is present in the storage unit 28 (step S7: YES), the process proceeds to step S8. In step S8, the display control unit 30 of the software update device 24 causes the display unit 54 of the IVI 48 to display the campaign information. Then, the process proceeds to step S9.

In step S9, the update processing unit 34 of the software update device 24 determines whether the user has permitted the software download. If it is determined that the software download has been permitted (step S9: YES), the process proceeds to step S10. If it is determined that the software download has not been permitted (step S9: NO), the software update control is terminated.

In step S10, the transmission processing unit 40 of the software update device 24 transmits an update data request to the server device 14. Then, the process proceeds to step S11.

In step S11, the update processing unit 34 of the software update device 24 downloads the software. Then, the process proceeds to step S12.

In step S12, the update processing unit 34 of the software update device 24 installs the software. Then, the software update control is terminated.

If it is determined in step S1 that the power mode of the vehicle 12 is not IG-ON (step S1: NO), the process proceeds to step S13.

In step S13, the update processing unit 34 of the software update device 24 determines whether the power mode of the vehicle 12 is IG-OFF. If it is determined that the power mode is IG-OFF (step S13: YES), the process proceeds to step S14. If it is determined that the power mode is not IG-OFF (step S13: NO), the software update control is terminated.

In step S14, the update processing unit 34 of the software update device 24 determines whether there is installed software. If it is determined that there is installed software (step S14: YES), the process proceeds to step S15.

In step S15, the update processing unit 34 of the software update device 24 determines whether the shift position is the P position. If it is determined that the shift position is the P position (step S15: YES), the process proceeds to step S16.

In step S16, the update processing unit 34 of the software update device 24 outputs a request for stopping the transmission process to the transmission processing unit 40. Then, the process proceeds to step S17.

In step S17, the transmission processing unit 40 of the software update device 24 stops the transmission process. Then, the process proceeds to step S18. By stopping the transmission process, no new transmission process is started. If the transmission retry is underway at the time when the request for stopping the transmission process is output, the transmission retry is immediately stopped.

In step S18, the display control unit 30 of the software update device 24 causes the display unit 54 of the IVI 48 to display the downtime permission information. Then, the process proceeds to step S19.

In step S19, the update processing unit 34 of the software update device 24 determines whether or not the user has permitted downtime. If it is determined that the downtime has been permitted (step S19: YES), the process proceeds to step S20.

In step S20, the update processing unit 34 of the software update device 24 activates the software. Then, the process proceeds to step S21.

In step S21, the log generation unit 38 of the software update device 24 generates a result log. Then, the process proceeds to step S22. The result log generated in step S21 includes information indicating that the software update process was successful.

In step S22, the discarding processing unit 36 of the software update device 24 discards the campaign information stored in the storage unit 28.

If it is determined in step S15 that the shift position is not the P position (step S15: NO), or if it is determined in step S19 that downtime has not been permitted (step S19: NO), the process proceeds to step S23. In step S23, the display control unit 30 of the software update device 24 causes the display unit 54 to display update infeasibility information indicating that software update cannot be updated. Then, the process proceeds to step S24.

In step S24, the log generation unit 38 of the software update device 24 generates a result log. The result log generated in step S24 includes information indicating that the software update process is incomplete.

After the process of the step S22 is completed, or after the process of the step S24 is completed, or when it is determined that there is no installed software in the step S14 (step S14: NO), the process proceeds to step S25. In step S25, the software update device 24 shuts down. Then, the software update control is terminated. Once the software update device 24 shuts down, the software update device 24 will not activate until the power mode of the vehicle 12 becomes IG-ON.

### Operation of Software Update Device

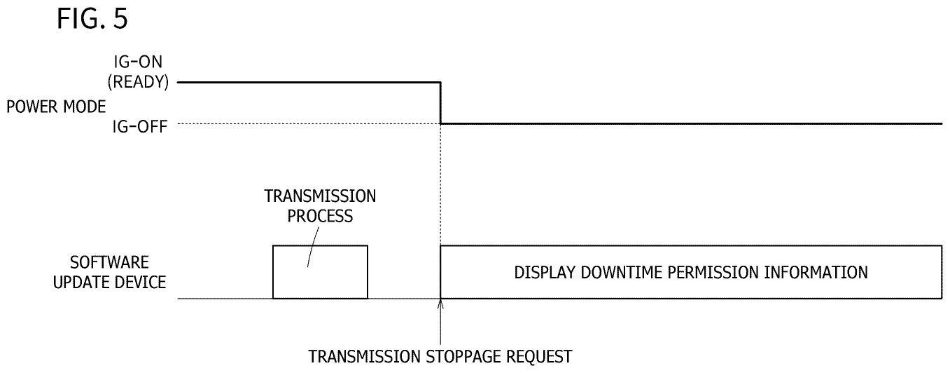

FIGS. 5 to 7 are diagrams for explaining the operation of the software update device 24. FIGS. 5 to 7 illustrate the operation of the software update device 24 during a period that includes the time point when the vehicle 12 is parked and the power mode of the vehicle 12 transitions from IG-ON to IG-OFF after the software installation is complete.

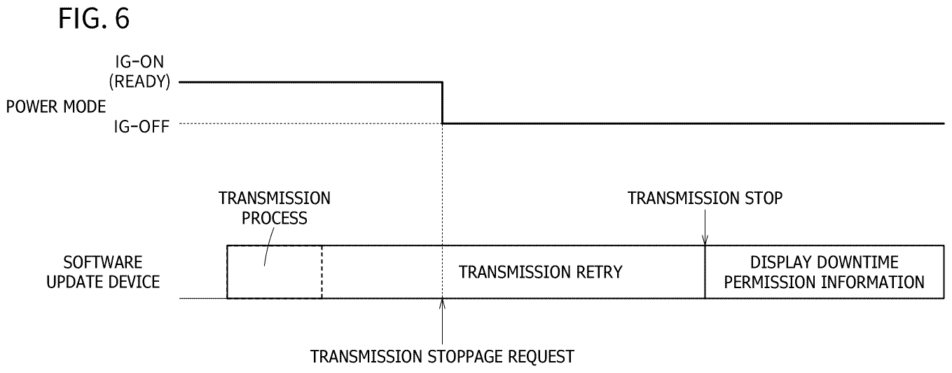

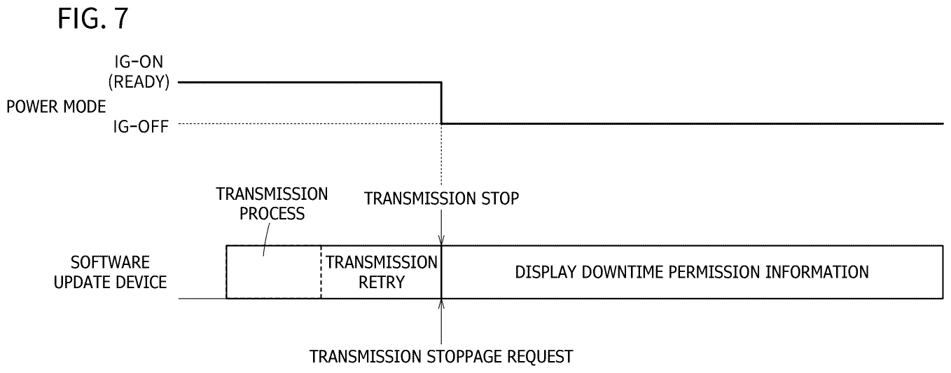

FIG. 5 shows the operation of the software update device 24 when the communication environment at a vehicle-parked place is favorable. FIG. 6 shows the operation of the conventional software update device 24 when the communication environment at the vehicle-parked place is not favorable. FIG. 7 shows the operation of the software update device 24 according to one embodiment when the communication environment at the vehicle-parked place is not favorable.

In the examples shown in FIGS. 5 to 7, the transmission process is performed before the power mode of the vehicle 12 transitions from IG-ON to IG-OFF.

When the power mode of the vehicle 12 is switched from IG-ON to IG-OFF, the update processing unit 34 outputs a request for stopping the transmission process to the transmission processing unit 40. When the request for stopping the transmission process is output, the transmission processing unit 40 does not start a new transmission process (FIG. 5). The display control unit 30 causes the display unit 54 of the IVI 48 to display the downtime permission information, and the update processing unit 34 performs the confirmation process for confirming with the user whether to permit the downtime. Thereby, the confirmation process is performed promptly after the power mode transitions from IG-ON to IG-OFF.

If the communication environment is not favorable and the transmission process fails, the transmission processing unit 40 performs a transmission retry, which performs the transmission process again (FIG. 6). The transmission retry is repeated until the transmission process succeeds or a predetermined time elapses since the start of the transmission process. Conventionally, at the time when the power mode of the vehicle 12 transitions from IG-ON to IG-OFF and a request for stopping a transmission process is output, if a transmission retry is being performed, the transmission process does not immediately stop but continues until the transmission process succeeds or until a predetermined time elapses from the start of the transmission process. Therefore, when the communication environment at the place where the vehicle 12 has been parked is not favorable and the transmission process is not successful, a relatively long time was sometimes required from the time point when the power mode transitioned from IG-ON to IG-OFF to the time point when the confirmation process was performed.

Therefore, in embodiment, if the power mode of the vehicle 12 transitions from IG-ON to IG-OFF and the transmission retry is being performed at the time when a request for stopping the transmission process is output, the transmission processing unit 40 stops the transmission retry (FIG. 7). Then, the display control unit 30 causes the display unit 54 of the IVI 48 to display the downtime permission information, and the update processing unit 34 performs the confirmation process for confirming with the user whether to permit the downtime. Thus, even when the communication environment at the vehicle-parked place is not favorable, the confirmation process is promptly performed after the power mode transitions from IG-ON to IG-OFF.

With respect to the above embodiments, the following supplementary notes are further disclosed.

### Supplementary Note 1

A software update system (10) of the present disclosure includes a vehicle (12), a server device (14) configured to communicate with the vehicle via a network (16), a power mode switch (56) configured to switch the power mode of the vehicle to at least one of a first mode in which a first number of electrical components among a plurality of electrical components mounted on the vehicle are operable and a second mode in which a second number of the electrical components smaller than the first number are operable, a transmission processing unit (40) configured to execute a transmission process for transmitting data to the server device, and an update processing unit (34) configured to execute a software update process for an electronic control unit provided in the vehicle in a case where the power mode is the second mode, wherein the transmission processing unit stops the transmission process and the update processing unit executes the software update process in a case where the transmission process has not succeeded at the time when the power mode is switched from the first mode to the second mode. Thus, even when the communication environment is not favorable, the software update process is promptly performed when the power mode is switched to the second mode.

### Supplementary Note 2

In the software update system described in Supplementary note 1, in a case where the transmission process fails, the transmission processing unit may execute a transmission retry for performing the transmission process again, and in a case where the transmission retry is being performed at the time when the power mode is switched from the first mode to the second mode, the transmission processing unit may stop the transmission retry, and the update processing unit may execute the software update process.

### Supplementary Note 3

In the software update system described in Supplementary note 1, the software update process may include a confirmation process for confirming with the user whether to permit software activation.

### Supplementary Note 4

A software update device (24) of the present disclosure is a software update device in the software update system according to any one of Supplementary notes 1 to 3, including the transmission processing unit and the update processing unit.

### Supplementary Note 5

A software update method of the present disclosure is a software update method for performing a software update process for an electronic control unit provided in a vehicle. The vehicle includes a power mode switch configured to switch, based on an operation by a user, the power mode of the vehicle to at least one of a first mode in which a first number of electric components among a plurality of electric components mounted on the vehicle are operable and a second mode in which a second number of electric components smaller than the first number are operable. The software method includes a transmission processing step in which a transmission processing unit executes a transmission process for transmitting data to a server device configured to communicate with the vehicle via a network, and an updating step in which an update processing unit executes the software update process in a case where the power mode is the second mode wherein in a case where the transmission process has not succeeded at a time when the power mode is switched from the first mode to the second mode, the transmission processing unit stops the transmission process in the transmission processing step, and the update processing unit executes the software update process in the update processing step.

### Supplementary Note 6

The software update method described in Supplementary note 5 may further include a transmission retry step in which the transmission processing unit executes a transmission retry for performing the transmission process again in a case where the transmission process fails, wherein in a case where the transmission retry is being performed at a time when the power mode is switched from the first mode to the second mode, the transmission processing unit may stop the transmission retry in the transmission retry step, and the update processing unit may execute the software update process in the update processing step.

### Supplementary Note 7

In the software update method described in Supplementary note 5, the software update process may include a confirmation process for confirming with the user whether to permit the software activation.

### Supplementary Note 8

A program of the present disclosure causes a computer to execute the software update method according to any one of Supplementary notes 5 to 7.

### Supplementary Note 9

A computer-readable non-transitory storage medium of the present disclosure stores the program according to Supplementary note 7.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A software update system comprising:
a vehicle;
a server device configured to communicate with the vehicle via a network;
a power mode switch configured to switch, based on an operation by a user, a power mode of the vehicle to at least one of a first mode in which a first number of electric components among a plurality of electric components mounted on the vehicle are operable and a second mode in which a second number of electric components smaller than the first number are operable; and
one or more processors configured to execute computer-executable instructions stored in a memory,
wherein
the one or more processors execute the computer-executable instructions to cause the software update system to:
perform a transmission process for transmitting data to the server device;
execute a software update process for an electronic control unit provided in the vehicle in a case where the power mode is the second mode; and
stop the transmission process and execute the software update process in a case where the transmission process has not succeeded at a time when the power mode is switched from the first mode to the second mode.

2. The software update system according to claim 1, wherein the one or more processors execute the computer-executable instructions to cause the software update system to:
perform a transmission retry for performing the transmission process again in a case where the transmission process fails; and
stop the transmission retry and execute the software update process in a case where the transmission retry is being performed at the time when the power mode is switched from the first mode to the second mode.

3. The software update system according to claim 1, wherein
the software update process includes a confirmation process for confirming with the user whether to permit software activation.

4. A software update device in the software update system according to claim 1, comprising
one or more processors that execute computer-executable instructions stored in a memory,
wherein
the one or more processors execute the computer-executable instructions to cause the software update device to:
perform a transmission process for transmitting data to the server device;
execute a software update process for an electronic control unit provided in the vehicle in a case where the power mode is the second mode; and
stop the transmission process and execute the software update process in a case where the transmission process has not succeeded at a time when the power mode is switched from the first mode to the second mode.

5. A software update method for performing a software update process for an electronic control unit provided in a vehicle by one or more processors,
wherein the vehicle includes a power mode switch configured to switch, based on an operation by a user, a power mode of the vehicle to at least one of a first mode in which a first number of electric components among a plurality of electric components mounted on the vehicle are operable and a second mode in which a second number of electric components smaller than the first number are operable,
the software update method comprising:
executing a transmission process for transmitting data to a server device configured to communicate with the vehicle via a network; and
executing the software update process in a case where the power mode is the second mode,
wherein
in a case where the transmission process has not succeeded at a time when the power mode is switched from the first mode to the second mode, the transmission process is stopped in the executing of the transmission process, and the software update process is executed in the executing of the software update process.

6. The software update method according to claim 5, further comprising
executing a transmission retry for performing the transmission process again in a case where the transmission process fails,
wherein in a case where the transmission retry is being performed at the time when the power mode is switched from the first mode to the second mode, the transmission retry is stopped in the executing of the transmission retry, and the software update process is executed in the executing of the software update process.

7. The software update method according to claim 5, wherein the software update process includes a confirmation process for confirming with a user whether to permit software activation.

8. A computer-readable non-transitory storage medium storing a program for causing a computer to execute the software update method according to claim 5.
